(19) United States
(12) Patent Application Publication
(10) Pub. No.: US 2009/0193146 A1
(43) Pub. Date: Jul. 30, 2009

(54) Utilizing Virtual Server Weight for Loadbalancing

(75) Inventors: Mark Albert, Cary, NC (US); Chris O'Rourke, Apex, NC (US); Senthil Kumar Pandian, Irvine, CA (US)

Correspondence Address: BAKER BOTTS L.L.P., 2001 ROSS AVENUE, SUITE 600, DALLAS, TX, 75201-2980, US

(73) Assignee: Cisco Technology, Inc., San Jose, CA (US)

(21) Appl. No.: 12/019,119

(22) Filed: Jan. 24, 2008

(51) Int. Cl. G06F 15/173

(52) U.S. Cl. 709/241

(57) ABSTRACT

In one embodiment, a method includes receiving current weight data from one or more hosts associated with a virtual server and configuring a maximum weight of the virtual server. The method includes communicating the sum of the current weight data from all of the hosts to a global loadbalancer and communicating the maximum weight of the virtual server to the global loadbalancer.

### TECHNICAL FIELD

The present disclosure relates generally to loadbalancing.

### BACKGROUND

Networking architectures have grown increasingly complex in communications environments. In addition, the augmentation of clients or end users wishing to communicate in a network environment has caused many networking configurations and systems to respond by adding elements to accommodate the increase in networking traffic.

As the subscriber base of end users increases, the need for executing proper loadbalancing techniques becomes more prevalent. In cases where inefficient loadbalancing techniques are executed, certain network components may be overwhelmed while other (potentially more capable) network resources remain untapped. This overburdening may decrease throughput and inhibit the flow of network traffic, causing congestion, inefficient use of computing recourses or bottlenecks in the system. Additionally, the overwhelming burden on a single element in the communications flow may decrease bandwidth capabilities and inhibit the ability to accommodate additional communications tunnels or end users.

### BRIEF DESCRIPTION OF THE DRAWINGS

FIG. 1 illustrates an example system for utilizing total weights of hosts to determine total vserver capacity for loadbalancing;

FIG. 2 illustrates a simplified block diagram for utilizing total weights of hosts to determine total vserver capacity for loadbalancing; and

FIG. 3 illustrates an example method utilizing total weights of hosts to determine total vserver capacity for loadbalancing.

### DESCRIPTION OF EXAMPLE EMBODIMENTS

Overview

In one embodiment, a method includes receiving current weight data from one or more hosts associated with a virtual server and configuring a maximum weight of the virtual server. The method includes communicating the sum of the current weight data from all of the hosts to a global loadbalancer and communicating the maximum weight of the virtual server to the global loadbalancer.

Description

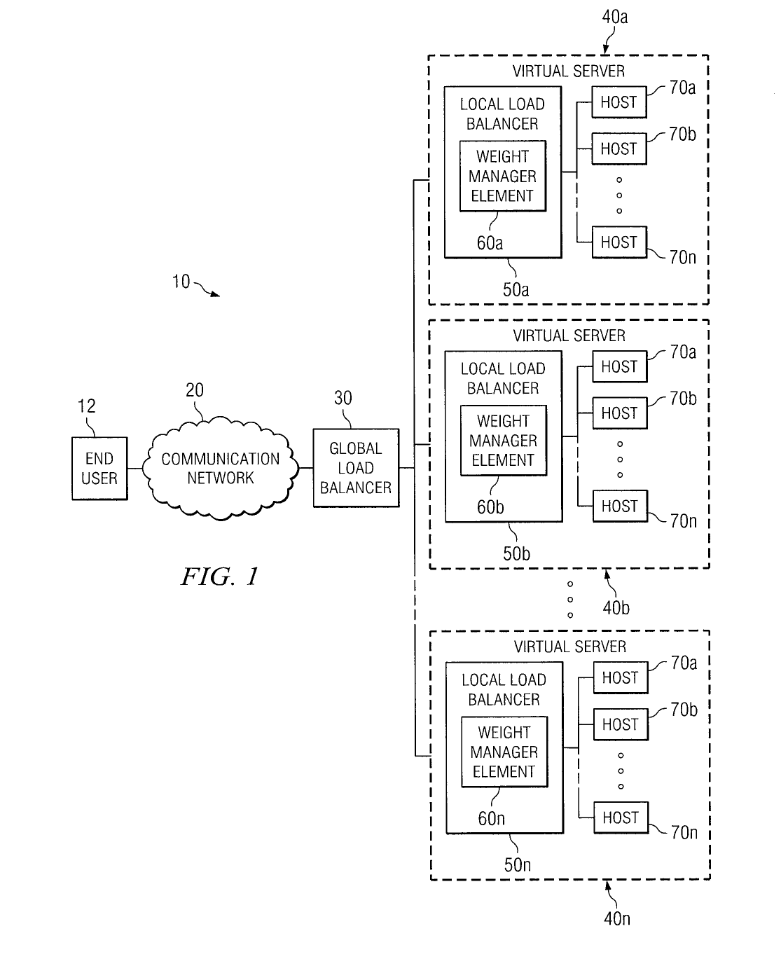

FIG. 1 is a simplified block diagram of a communication system 10 for utilizing total weights of hosts to determine total vserver capacity for loadbalancing. Communication system 10 includes an end user 12, a communication network 20, a global loadbalancer 30, and a virtual server 40 (i.e., a set of virtual servers 40a-n). Virtual server 40 may include local loadbalancer 50 (i.e., a set of local loadbalancers 50a-n) and one or more hosts 70 (i.e., a set of hosts 70a-n). Local loadbalancer 50 may include a weight manager element 60 (i.e., a set of weight manager elements 60a-n).

In accordance with the teachings of the present disclosure, weight manager element 60 allows network operator to configure the maximum weight of virtual server 40, such that the maximum weight represents the summation of the total weight of all hosts 70 within a given virtual server 40. Weight may represent a metric, such as the host's capacity to handle more connections and/or to process more work. Weight manager element 60 may utilize algorithms to calculate the health of virtual server 86. In one embodiment, health of virtual server may be the quotient of the current weight of virtual divided by the maximum weight of virtual server. In one embodiment, health of virtual server may be the quotient of the number of active serving hosts divided by the total number of provisioned hosts. The maximum weight of the virtual server and the health of the virtual server are communicated to global loadbalancer 30. Therefore, the decisions by global loadbalancer 30 of how to distribute work are influenced by the maximum weight of virtual server 40 and the health of the virtual server 40, such that global loadbalancer 30 can send requests to virtual server 40 that has more available capacity than another virtual server 40.

In operation of an example embodiment, end user 12 is located in Arizona and attempts to connect to www.xyz.com. This DNS request is sent to global loadbalancer 30. Global loadbalancer 30 utilizes an algorithm to determine which IP address to direct end user's request based on one or more factors, such as round trip time, maximum weight, and health of www.xyz.com's data centers. For example and for purposes of explanation only, www.xyz.com may have two data centers 40 associated with its domain name, such as virtual server A and virtual server B. Virtual server A is located in California and virtual server B is located in New York. Virtual server A has one server operating at eighty percent capacity with a weight of ten. Virtual server B has fifty servers, such that each server is operating at eighty percent capacity with a weight of ten. Weight manager element 60 of virtual server A may be configured to show a total weight of ten. Weight manager element 60 of virtual server B may be configured to show a total weight of five hundred. Global loadbalancer 30 algorithm may determine which virtual server 40 to send a request based on several factors, such as round trip time of a request to virtual servers A and B, health of virtual servers A and B, and total weight of virtual servers A and B. Without weight manager element 60, global loadbalancer algorithm cannot utilize the total weight of virtual server 40, which is an important factor in determining how to distribute requests. Global loadbalancer algorithm may determine to send a request to virtual server B even if it is not as healthy as virtual server A because virtual server B has a much higher maximum weight than virtual server A. Local loadbalancer 50 within virtual server B may distribute a request to a host based on current weights determined by a server feedback protocol, such as a Dynamic Feedback Protocol.

End user 12 may be a client, customer, entity, source, or object seeking to initiate network communication in communication system 10 via communication network 20. End user 12 may be inclusive of devices used to initiate a communication, such as a computer, a personal digital assistant (PDA), a laptop or an electronic notebook, a telephone, a mobile station, or any other device, component, element, or object capable of initiating voice or data exchanges within communication system 10. End user 12 may also be inclusive of a suitable interface to the human user, such as a microphone, a display, a keyboard, or other terminal equipment (such as for example an interface to a personal computer or to a facsimile machine in cases where end user 12 is used as a modem). End user 12 may also be any device that seeks to initiate a communication on behalf of another entity or element, such as a program, a database, or any other component, device, element, or object capable of initiating a voice or a data exchange within communication system 10. Data, as used herein in this document, refers to any type of packet, numeric, voice, video, graphic, or script data, or any type of source or object code, or any other suitable information in any appropriate format that may be communicated from one point to another.

System 10 includes a communication network 20. In general, communication network 20 may comprise at least a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication links, or any combination of any of the preceding. Communication network 20 may implement any suitable communication protocol for transmitting and receiving data or information within communication system 10.

Loadbalancer 30, 50 may be global loadbalancer 30 or local loadbalancer 50. Loadbalancers 30, 50 are elements or devices that receive requests and distribute those requests to the next available server or node. The server or node may be any host, computer, or device on a network that manages network resources or that processes data, such as virtual servers 40 and hosts 70. In one example, the next available server or node may be another loadbalancer 30, 50. Loadbalancing decisions may be executed based on suitable algorithms, software, or hardware provided in loadbalancer 30, 50. Loadbalancer 30, 50 may also include hardware and/or software for directing signaling and data information in communication system 10. Hardware within a switch fabric of loadbalancer 30, 50 may operate to direct information based on IP address data provided in the communication flows. Software within loadbalancer 26 may properly accommodate a signaling pathway for transmissions associated with end user 12 and selected virtual servers or hosts.

Loadbalancer 30, 50 may also perform other suitable loadbalancing tasks, such as dividing the amount of work that an element has to do between two or more elements to ensure more work gets done in the same amount of time and, in general, accommodating end users 12 more quickly. Loadbalancer 30, 50 may be replaced by any other suitable network element such as a router, a switch, a bridge, a gateway, or any other suitable element, component, device, or object operable to facilitate data reception or transmission in a network environment. Additionally, loadbalancer 30, 50 may include any appropriate hardware, software, (or a combination of both) or any appropriate component, device, element, or object that suitably assists or facilitates traffic management in a network. The operation of loadbalancer 30, 50 may further alleviate strain that is placed on virtual servers 40 and hosts 70 that continue to receive requests that they are incapable of accommodating.

Loadbalancers 30, 50 may support a Dynamic Feedback Protocol (DFP). DFP allows host 70 to communicate a metric identifying the weight or capacity of host 70. The loadbalancer 30, 50 and/or weight manager element may use this metric of a host's weight to determine how much additional processing host 70 can support. DFP weights of host 70 may be compared to other weights of hosts within a server farm since the DFP weights may be relative to other hosts 70 within virtual server 40.

Global loadbalancer 30 may do geographic loadbalancing across multiple virtual servers, such as Domain Name System (DNS) loadbalancers. In one particular embodiment, when end user 12 makes a DNS request, global loadbalancer 30 utilizes an algorithm to determine which virtual server 40 should handle the DNS request. Such algorithms may intelligently use several factors, such as round trip time and weight metrics of virtual server. Weight metrics of virtual server may include maximum weight of virtual server, current weight of virtual server, health of virtual server, or any appropriate metric. As illustrated below, weight manager element 60 may communicate these weight metrics, including the maximum weight of virtual server to global loadbalancer 30, such that global loadbalancer 30 can make better decisions as to which virtual server 40 should receive the current request. Therefore, global loadbalancing algorithms may now utilize virtual server's maximum weight, current weight, and/or health.

Virtual server 40 may represent a server farm or data center of hosts that can perform work. Virtual server 40 may use a single IP address to represent local loadbalancer 50 and hosts 70. Virtual server 40 may communicate as host 70 to global load balancer 30, such that virtual server communicates its weight to global loadbalancer.

Local loadbalancer 50 may act as a manager by receiving DFP weights and as an agent by communicating DFP weights to global loadbalancer 30. As an agent, local loadbalancer 50 is represented as a host to global loadbalancer 30. Local loadbalancer 50 provides weights representing capacity of virtual server 40. As discussed below, weight manager element 60 may be located in local loadbalancer 50 and weight manager element may be configured with a maximum weight of all hosts 70 within virtual server 40, such that more detailed information of virtual server weight is communicated to global loadbalancer 30. As a manager, local loadbalancer 50 utilizes an algorithm to determine how to distribute requests to hosts 70 based on factors, such as DFP weights.

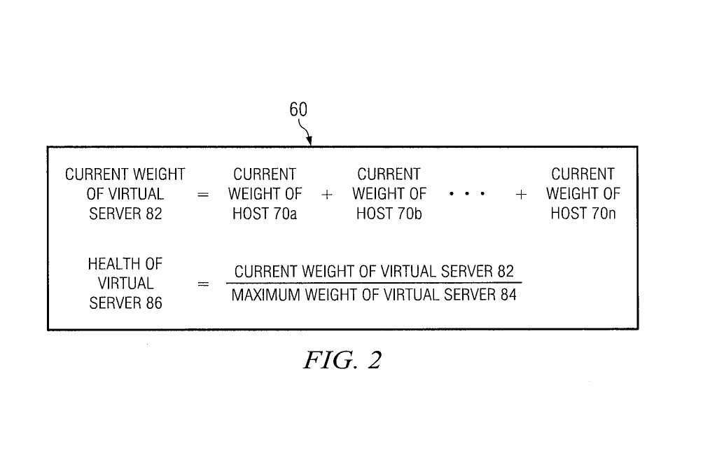

Weight manager element 60 is an element that allows a network operator to configure the maximum weight of virtual server 40, such that the maximum weight represents the summation of the total weight of all hosts 70 within virtual server. Weight may represent a metric, such as host's capacity to handle more connections and process more work. Weight manager element 60 may track the total host weights. Weight manager element 60 may also utilize algorithms to calculate the current weight of virtual server 40 and/or the health of virtual server 40. The current weight of a host may be a metric that identifies how much weight the host is currently processing. The total weight of a host may be a metric that identifies how much total weight the host can process. For example, a host that does not have any requests may have a current weight of zero, and a host that has one or more requests may have a metric greater than zero for the current weight. The host can not process more weight than its total weight. As the current weight of each hosts increase or decrease, the current weight of virtual server may increase or decrease accordingly. Weight manager element may determine the current weight of virtual server. This metric of the current weight of virtual server is explained in more detail below in FIG. 2. Weight manager element may communicate the maximum weight of virtual server, the current weight of virtual server, and/or the health of virtual server.

In an alternative embodiment, health of virtual server 40 may be the total number of active serving hosts 70 divided by the total number of provisioned hosts 70. Weight manager element 60 may communicate the current health of virtual server 40 to global loadbalancer 30. Additionally, weight manager element 60 may communicate the maximum weight of virtual server 40 to global loadbalancer 30.

The maximum weight of virtual server 40 may be configured by network operator. Global loadbalancer 30 may receive a maximum weight of virtual server 40. Additionally, global loadbalancer may receive the current weight of virtual server 40 and/or the health of virtual server 40. Global loadbalancer 30 may normalize the health of virtual server by appropriately scaling this metric with the maximum capacity of virtual server 40. Therefore, decisions by global loadbalancer 30 of how to distribute work are influenced by the maximum weight of all hosts 70 located within virtual server 40, such that global loadbalancer 30 may send requests to virtual server 40 that has more available capacity than another virtual server 40. As discussed below in FIG. 2, weight manager element 60 may utilize several algorithms to determine an appropriate metric.

Weight manager element 60 allows network operators to implement data centers that are not identical to one another. Without utilizing the maximum weight of a virtual server configured in weight manager element 60, global loadbalancer 30 may treat one hundred hosts with fifty percent capacity represented by virtual server A identically to a single host with fifty percent load represented by virtual server B because the loads are not scaled to appropriately identify the total capacity. After weight manager element 40 communicates the maximum weight of virtual server with the current weight and/or health of virtual server, then global loadbalancer 30 may determine that virtual server A is a better destination to process the request because virtual server A has much more capacity than virtual server B.

It is critical to note that loadbalancers 30, 50 and weight manager element 60 may include any suitable elements, hardware, software, objects, or components capable of effectuating their operations or additional operations where appropriate. The software could include code such that when executed is operable to perform the functions outlined herein. Additionally, any one or more of the elements included in loadbalancers 30, 50 and weight manager element 60 may be provided in an external structure or combined into a single module or device where appropriate. Moreover, any of the functions provided by loadbalancers 30, 50 and weight manager element may be offered in a single unit or single functionalities may be arbitrarily swapped between loadbalancers 30, 50 and weight manager element 60. The embodiment offered in FIG. 1 has been provided for purposes of example only. The arrangement of elements (and their associated operation(s)) may be reconfigured significantly in any other appropriate manner in accordance with the teachings of the present disclosure.

System includes hosts 70, such that hosts are real servers. Hosts 70 may communicate current weight to local loadbalancers by DFP. In one embodiment, one or more hosts 70 may be physically distributed such that each host 70, or multiple instances of each host 70, may be located in a different physical location geographically remote from each other. In other embodiments, one or more hosts may be combined and/or integral to each other. One or more hosts 70 may be implemented using a general-purpose personal computer (PC), a Macintosh, a workstation, a UNIX-based computer, a server computer, or any other suitable processing device. Hosts 70 may further comprise a memory. The memory may take the form of volatile or non-volatile memory including, without limitation, magnetic media, optical media, random access memory (RAM), read-only memory (ROM), removable media, or any other suitable local or remote memory component.

FIG. 2 illustrates a simplified block diagram utilizing total weights of hosts to determine total vserver capacity for loadbalancing in accordance with one embodiment of the present disclosure. Several different algorithms may be used by weight manager element 60 to determine one or more appropriate metrics to communicate to global loadbalancer 30. The following algorithms are for example and discussion only. Accordingly, weight manager element 60 is not limited to the algorithms listed below. The current weight of virtual server 82 may be obtained by summation of the current weight of all hosts within virtual server. Maximum weight of virtual server 84 may be configured by network operator. Health of virtual server 86 may be obtained by division of current weight of virtual server 82 by maximum weight of virtual server 84. Additionally, weight manager element 60 may communicate the current weight 82, maximum weight 84, and health of virtual server 86 to global loadbalancer 30, such that global loadbalancer 30 scales the weights of each virtual server 40 appropriately. In an alternative embodiment, health of virtual server 40 may be the quotient of the total number of active serving hosts 70 divided by the total number of provisioned hosts 70.

In an example embodiment, virtual server 40 includes four hosts: host1 with 10 maximum weight, host2 with 20 maximum weight, host3 with 30 maximum weight, and host4 with 40 maximum weight. Operator of virtual server may have knowledge of each host's maximum weight, and the operator may configure the total maximum weight of virtual server to one hundred. While processing end user requests, the four hosts may report current weights using DFP, such that host1 has 5 current weight, host2 has 10 current weight, host3 has 20 current weight, and host 4 has 25 current weight. Weight manager element 60 may compute that the virtual server is at 60% capacity by dividing the sum of the current weights, sixty, by the maximum configured weight of one hundred. Assuming no other constraints on capacity, global loadbalancer 30 may receive data indicating that health of virtual server 40 is 60%, such that virtual server is at 60% capacity out of a maximum capacity of one hundred.

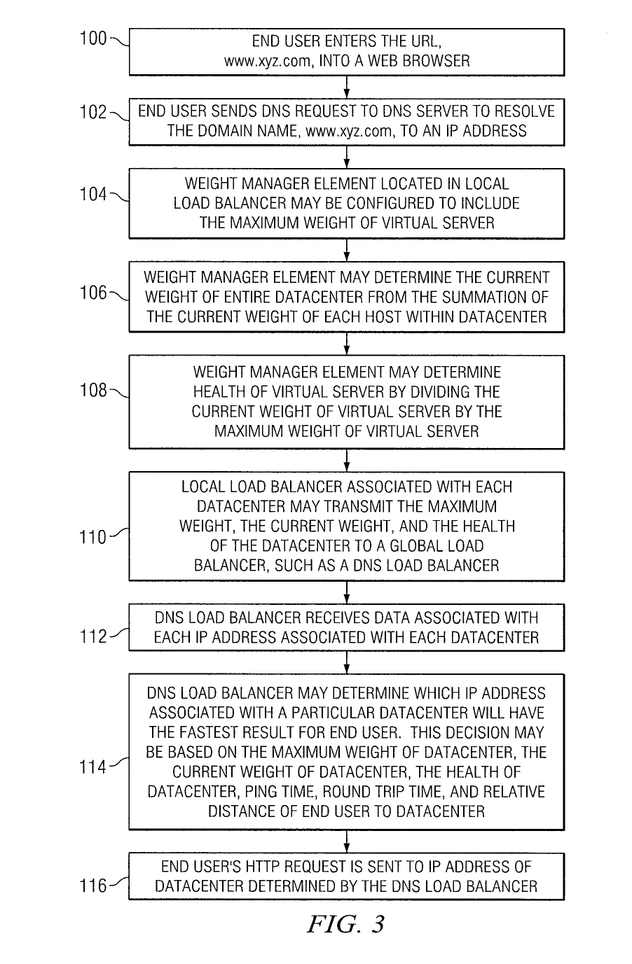

FIG. 3 illustrates an example method for utilizing total weights of hosts to determine total vserver capacity for loadbalancing in accordance with one embodiment of the present disclosure. The flowchart may begin at step 100 when end user 12 enters the URL, www.xyz.com, into a web browser.

At step 102, end user 12 sends DNS request to DNS server to resolve the domain name, www.xyz.com, to an IP address. Each IP address is associated with different datacenters located in different geographic areas in the country. Each datacenter is represented as a virtual server, which includes local loadbalancer and hosts.

At step 104, weight manager element located in local loadbalancer may be configured to include the maximum weight of virtual server. At step 106, weight manager element may determine the current weight of the entire datacenter from the summation of the current weights of each host within the datacenter. Current weights of each host may be determined by a server feedback protocol, such as a Dynamic Feedback Protocol. At step 108, weight manager element 60 may determine the health of the virtual server by dividing the current weight of the virtual server by the maximum weight of the virtual server

At step 110, a local loadbalancer associated with each datacenter may transmit the maximum weight, the current weight, and the health of the datacenter to a global loadbalancer, such as a DNS loadbalancer.

At step 112, the global loadbalancer, such as DNS loadbalancer, receives data associated with each IP address associated with each datacenter. The data may include the maximum weight, the current weight, and the health of the datacenter. Other data may include ping time, round trip time, and relative distance of each datacenter to end user.

At step 114, the DNS loadbalancer may determine which IP address associated with a particular datacenter will have the fastest result for end user 12. This decision may be based on the maximum weight of datacenter, the current weight of datacenter, the health of datacenter, ping time, round trip time, and relative distance of end user to datacenter. At step 116, the end user's HTTP request is sent to the IP address of the datacenter determined by the DNS loadbalancer.

Some of the steps illustrated in FIG. 3 may be changed or deleted where appropriate and additional steps may also be added to the flowcharts. These changes may be based on specific communication architectures or particular interfacing arrangements and configurations of associated elements and do not depart from the scope or the teachings of the present disclosure. The interactions and operations of the elements within loadbalancers 30, 50 and weight manager element 60, as disclosed in FIG. 3, have provided merely one example for their potential applications. Numerous other applications may be equally beneficial and selected based on particular networking needs.

Although the present disclosure has been described in detail with reference to particular embodiments, communication system 10 may be extended to any scenario in which end user 12 is utilizing weight manager element 60 to determine maximum weight capacity. Additionally, although communication system 10 has been described with reference to a number of elements included within loadbalancers 30, 50 and weight manager element 60, these elements may be rearranged or positioned anywhere within communication system 10. In addition, these elements may be provided as separate external components to communication system 10 where appropriate. The present disclosure contemplates great flexibility in the arrangement of these elements as well as their internal components. Moreover, although FIGS. 1 and 2 illustrate an arrangement of selected elements, numerous other components and algorithms may be used in combination with these elements or substituted for these elements without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. An apparatus, comprising:
a weight manager element located in a local loadbalancer associated with a virtual server, the weight manager element operable to:
receive current weight data from one or more hosts associated with the virtual server; and
receive a maximum weight of the virtual server.

2. The apparatus of claim 1, wherein the weight manager element is further operable to:
communicate a sum of the current weight data from all of the hosts to a global loadbalancer; and
communicate the maximum weight of the virtual server to the global loadbalancer.

3. The apparatus of claim 1, wherein the weight manager element is further operable to:
determine health of the virtual server by dividing sum of the current weight data from the one or more hosts by the maximum weight of the virtual server.

4. The apparatus of claim 3, wherein the weight manager element is further operable to:
communicate the health of the virtual server to a global loadbalancer; and
communicate the maximum weight of the virtual server to the global loadbalancer.

5. The apparatus of claim 4, wherein the global loadbalancer is operable to utilize the health of the virtual server and the maximum weight of the virtual server to determine where a request is routed.

6. The apparatus of claim 1, wherein the current weight data from the one or more hosts is determined by utilizing Dynamic Feedback Protocol.

7. The apparatus of claim 1, wherein the maximum weight of the virtual server is received from a network operator.

8. A method, comprising:
receiving current weight data from one or more hosts associated with the virtual server; and
receiving a maximum weight of the virtual server.

9. The method of claim 8, further comprising:
communicating a sum of the current weight data from all of the hosts to a global loadbalancer; and
communicating the maximum weight of the virtual server to the global loadbalancer.

10. The method of claim 8, further comprising:
determining health of the virtual server by dividing a sum of the current weight data from the one or more hosts by the maximum weight of the virtual server.

11. The method of claim 10, further comprising:
communicating the health of the virtual server to a global loadbalancer; and
communicating the maximum weight of the virtual server to the global loadbalancer.

12. The method of claim 11, wherein the global loadbalancer is operable to utilize the health of the virtual server and the maximum weight of the virtual server to determine where a request is routed.

13. The method of claim 8, wherein the current weight data from the one or more hosts is determined by utilizing a Dynamic Feedback Protocol.

14. The method of claim 8, wherein the maximum weight of the virtual server is received from a network operator.

15. An apparatus, comprising:
means for receiving current weight data from one or more hosts associated with the virtual server; and
means for receiving a maximum weight of the virtual server.

16. The apparatus of claim 15, further comprising:
means for communicating sum of the current weight data from all of the hosts to a global loadbalancer; and
means for communicating the maximum weight of the virtual server to the global loadbalancer.

17. The apparatus of claim 15, further comprising:
means for determining health of the virtual server by dividing sum of the current weight data from the one or more hosts by the maximum weight of the virtual server.

18. The apparatus of claim 17, further comprising:
means for communicating the health of the virtual server to a global loadbalancer; and
means for communicating the maximum weight of the virtual server to the global loadbalancer.

19. The apparatus of claim 18, wherein the global loadbalancer comprises means for utilizing the health of the virtual server and the maximum weight of the virtual server to determine where a request is routed.

20. The apparatus of claim 15, wherein the global loadbalancer comprises means for utilizing the health and the maximum weight of the virtual server to determine where a request is routed.
